(19) United States
(12) Patent Application Publication
(10) Pub. No.: US 2024/0246574 A1
(43) Pub. Date: Jul. 25, 2024

(54) MULTIMODAL TRAJECTORY PREDICTIONS BASED ON GEOMETRIC ANCHORING

(71) Applicant: GM Cruise Holdings LLC, San Francisco, CA (US)

(72) Inventors: Adam Abdulhamid, San Francisco, CA (US); Thanard Kurutach, Carrboro, NC (US)

(21) Appl. No.: 18/158,183

(22) Filed: Jan. 23, 2023

(51) Int. Cl. B60W 60/00

(52) U.S. Cl. CPC B60W 60/0027; B60W 2552/10; B60W 2554/402; B60W 2554/4041; B60W 2554/4042

(57) ABSTRACT

Systems and techniques are provided for multimodal trajectory predictions of an object near an autonomous vehicle (AV) based on geometric anchoring. An example process can include identifying one or more predicted trajectories of an object within a proximity of an AV; assigning modes to the one or more predicted trajectories, wherein a respective mode is assigned to each predicted trajectory of the one or more predicted trajectories based on a geometry of the predicted trajectory of the object; determining probabilities of the modes based on one or more parameters, wherein a first mode of the modes is associated with a first probability and a second mode of the modes is associated with a second probability; and updating a planned behavior of the AV based on a combination of the first mode associated with the first probability and the second mode associated with the second probability.

### BACKGROUND

### 1. Technical Field

The present disclosure generally relates to trajectory predictions and, more specifically, to multimodal trajectory predictions of an object around an autonomous vehicle based on geometric anchoring.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates an example diagram of geometry-based labeling of modes for predicted trajectories, according to some aspects of the present disclosure;

FIG. 3 is a diagram illustrating example predicted trajectories of an object, according to some aspects of the present disclosure;

FIG. 4 illustrates an example road environment for trajectory predictions of a vehicle based on geometric anchoring, according to some aspects of the present disclosure;

FIG. 5 illustrates an example road environment for trajectory predictions of a bike based on geometric anchoring, according to some aspects of the present disclosure;

FIG. 6 illustrates an example process for determining multimodal trajectory predictions of an object based on geometric anchoring, according to some aspects of the present disclosure; and

FIG. 7 illustrates a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, an Inertial Measurement Unit (IMU), a light detection and ranging (LIDAR) sensor, a radio detection and ranging (RADAR) sensor, an audio sensor, amongst others, which the AVs can use to collect data and measurements that the AVs can use for operations such as navigation. The AVs can use the various sensors to collect data and measurements that the AVs can use for AV operations such as perception (e.g., object/event detection, tracking, localization, sensor fusion, point cloud processing, image processing, etc.), planning (e.g., route planning, trajectory planning, situation analysis, behavioral and/or action planning, mission planning, etc.), prediction (e.g., motion prediction, behavior prediction, etc.), control (e.g., steering, braking, throttling, lateral control, etc.), etc. The sensors can provide the data and measurements to an internal computing system of the AV, which can use the data and measurements to control a mechanical system of the AV, such as a vehicle propulsion system, a braking system, or a steering system.

To ensure safe and efficient operations, AVs are required to accurately perceive the driving environment including objects, traffic elements, and road features surrounding the AVs for planning and controlling the AV operations. For example, AVs need to accurately identify the current locations and configurations of nearby objects in the driving environment and predict and determine possible future trajectories of the objects over time to fully understand and account for predicted changes in the driving environment.

In some cases, a trajectory prediction model predicts multiple possible trajectories of an object, such as Gaussian trajectory distributions, and a categorical distribution over these Gaussians. However, training a multi-modal distribution often results in a mode collapse where multiple mode indexes end up predicting similar (or identical) trajectories with extremely low variety and missing trajectories that have a lower yet recognizable probability. Accordingly, there exists a need for improved trajectory prediction systems and techniques to adequately account for diversity between the predicted trajectories that the model produces and avoid a mode collapse. Further, there exists a need for a multimodal formulation that can produce better mode convergence that can avoid mode collapse, especially at intersections.

Described herein are systems, apparatuses, processes (also referred to as methods), and computer-readable media (collectively referred to as “systems and techniques”) for multimodal trajectory predictions of an object that is located around an AV based on geometric anchoring. In some examples, the systems and techniques described herein can assign modes (e.g., semantic behaviors) to predicted trajectories of an object based on the geometry of the predicted/future trajectories of the object, by which process can be referred to as geometric anchoring. As follows, the systems and techniques described herein can provide multimodal trajectory predictions that can cover different semantic behaviors (e.g., performing a right or left turn, performing a U-turn, traveling in a forward or reverse direction, staying stationary, etc.) so that an AV (e.g., a planning stack) can respond or prepare to respond to a lower probability trajectory at an earlier stage.

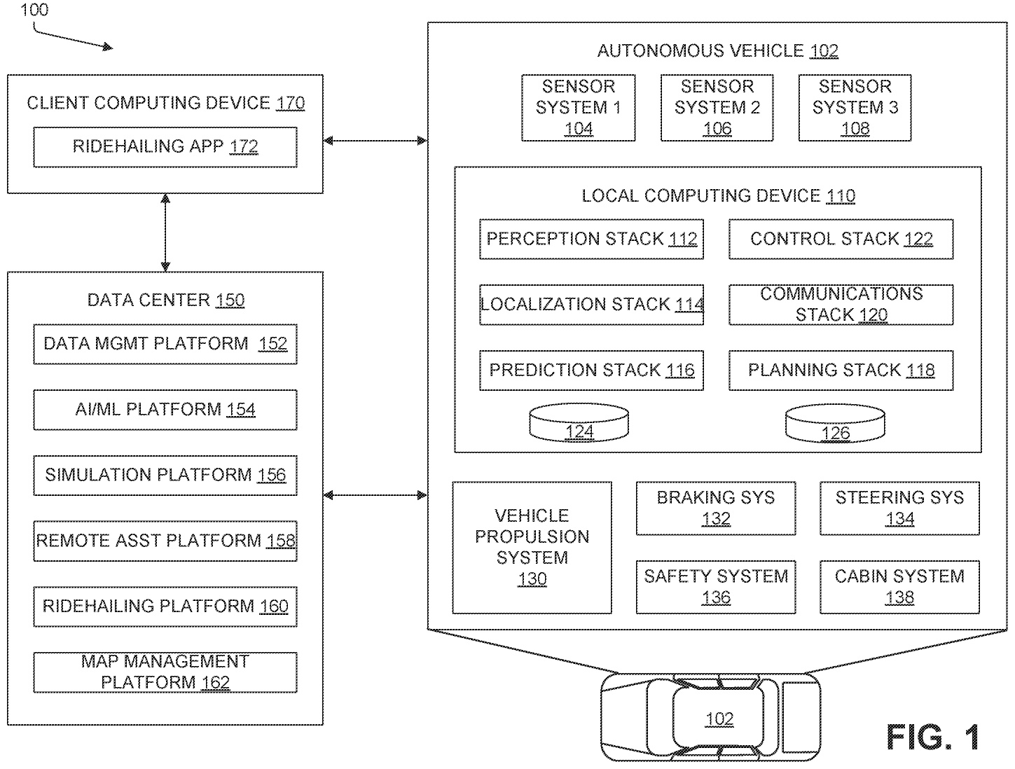

To illustrate, an AV (e.g., a prediction stack 116 of AV 102 as illustrated in FIG. 1) can output one or more predicted trajectories of an object (e.g., a vehicle, pedestrian, bike, etc.) that describe a future path/position(s) that the object is likely to take. It is critical to accurately predict the trajectories of an object so that the AV can plan accordingly, for example, whether to yield to the object or assert, so that a safety critical event (e.g., a collision/crash, a near miss, or any event that may risk the safety of operations of AV 102) can be avoided and the AV can navigate safely and efficiently. Further, an AV (e.g., a prediction stack 116 of AV 102 as illustrated in FIG. 1) can output a probability associated with each trajectory.

In some examples, for each predicted trajectory of an object, the systems and techniques described herein can assign modes (e.g., semantic behaviors of the predicted trajectories) based on the geometry of the future/predicted trajectory of the object, which can include an angle and/or vector of the object at the time between a first timestamp (e.g., time t) and a second timestamp (e.g., time t+k second(s)). In other words, one or more predicted trajectories of the object are grouped into modes based on a heading angle of the object at the current timestamp (e.g., time t) and the future endpoint (e.g., time t+k second(s)) such as an angle between the current pose of the object and the future position of the object. In some examples, k can be any number to indicate any future time. Those skilled in the art will recognize that the present technology is not limited to any particular time interval or window for the future timestamp (e.g., the second timestamp). Non-limiting examples of modes can include staying stationary (e.g., staying within a predetermined radius), traveling in a forward direction, performing a right turn, performing a left turn, performing a U-turn, traveling in a reverse direction, etc. In some examples, the modes can be as finely classified as to include performing a sharp/tight left turn, performing a wide left turn, performing a lane change, etc. As follows, a mode can reflect the predicted trajectory of an object based on semantic behaviors and/or geometry of the predicted trajectory of the object.

In some aspects, the systems and techniques described herein can determine probabilities of modes based on various parameters such as characteristics of the object (e.g., a type, location, position, orientation, speed, configuration, etc.), environmental elements including scene features and/or road features, relevant predicted trajectories and associated probabilities, or any applicable factors that may affect the future path of the object.

In some cases, the systems and techniques described herein can plan how to maneuver or operate the AV based on the combination of modes, for example, including the mode that has a lower probability than other modes so that even a low-probability event can be captured at an earlier stage and the AV can respond in a safe and efficient manner. In other words, the systems and techniques of the present disclosure can cover different semantic behaviors including a low-probability trajectory of the object, and plan and/or adjust the behavior of AV accordingly.

For example, multiple trajectories of a vehicle, with a high probability, predict that the vehicle will travel in a forward direction at various speeds. A couple of trajectories of the vehicle, with a low probability, indicate that the vehicle will cut in. Instead of selecting a few top high-probability trajectories and excluding the low-probability trajectories, the systems and techniques described herein can assign modes to all trajectories of the vehicle based on the geometry of the future trajectories of the vehicle (e.g., an angle between the current pose of the vehicle and a future position of the vehicle). In some examples, the systems and techniques described herein can implement the above-described process during the time when the model is trained. As follows, a diversity of future trajectories can be achieved during training. For example, the systems and techniques can generate predictions of x % of mode A (e.g., 90% of traveling straight) and y % of mode B (e.g., 10% of cutting in) with respect to a nearby object instead of x % of traveling straight and 10% of traveling straight at a slightly different angle. Further, the systems and techniques can plan maneuvers/behaviors of an AV based on both modes (e.g., a mode for traveling in a forward direction and a mode of a cut-in) so that an AV can brake smoothly for the cut-in and avoid a safety critical event (e.g., a collision or near miss).

As illustrated, a geometric anchoring formulation of the present disclosure (e.g., geometry-based multi-modal trajectory predictions) can ensure that the predicted trajectories are spread out, thereby providing diversity between the trajectories and avoiding a potential mode collapse. As follows, improvements in the safety and comfort of operations of an AV can be achieved.

Various examples of the systems and techniques for providing multimodal trajectory predictions of an object around an AV based on geometric anchoring are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing/ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service (e.g., a ridesharing service) via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 1160 can receive requests to pick up or drop off from the ridehailing application 1172 and dispatch the AV 1102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some cases, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 (e.g., client application) to enable passengers to view the AV 102 in transit en route to a pick-up or drop-off location, and so on.

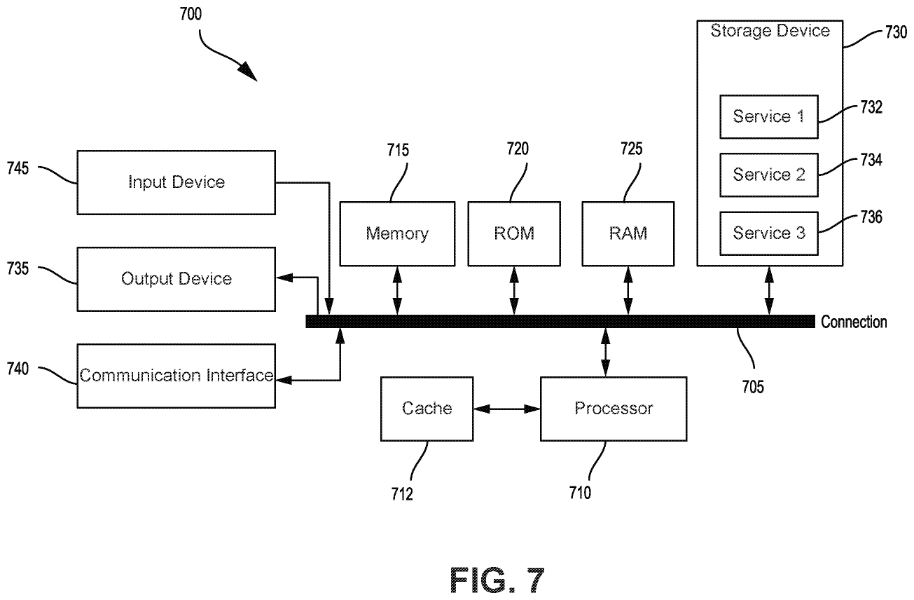

While the autonomous vehicle 102, the local computing device 110, and the AV environment 100 are shown to include certain systems and components, one of ordinary skill will appreciate that the autonomous vehicle 102, the local computing device 110, and/or the AV environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

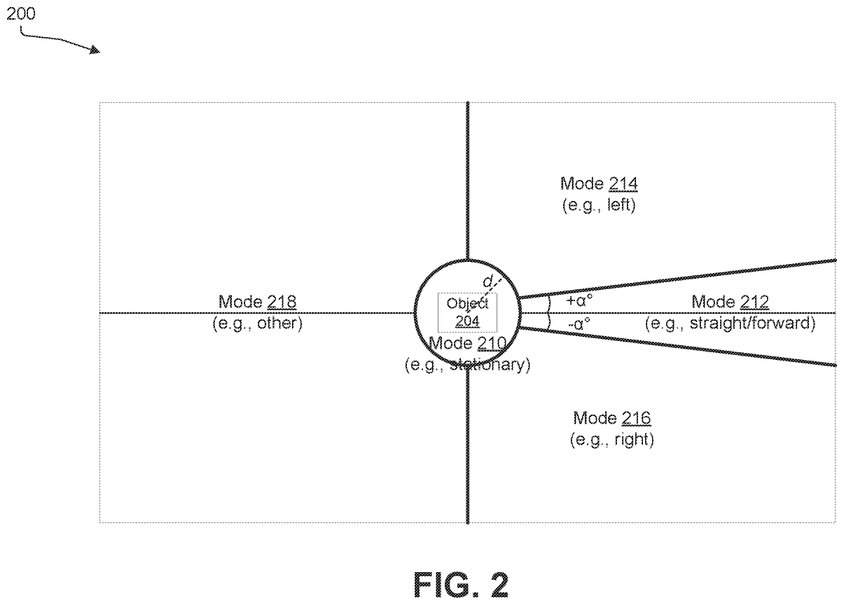

FIG. 2 illustrates an example quadrant 200 for labeling modes for predicted trajectories based on the geometry of the predicted trajectories of an object. As noted previously, a predicted trajectory of object 204 depicts a future path that object 204 is likely to take over a certain time such as a time between a first timestamp (e.g., time t) and a second timestamp (e.g., time t+k second(s) or future endpoint). Example quadrant 200 for labeling modes illustrates which mode can be assigned to a particular predicted trajectory of object 204 based on the geometry of the particular predicted trajectory of object 204.

Example quadrant 200 for labeling modes classifies one or more predicted trajectories of object 204 into a respective mode (e.g., modes 210, 212, 214, 216, 218) based on the geometry of the one or more predicted trajectories of object 204 at a time between the first timestamp (e.g., time t) and the second timestamp (e.g., time t+k second(s) or future endpoint). In some cases, the geometry of the predicted trajectories of object 204 that can be used to determine a mode for a particular predicted trajectory includes an angle and/or vector of object 204 at the time between the first timestamp and the second timestamp. More specifically, a heading angle (e.g., the direction in which object 204 is pointing) at the time between the first timestamp and the second timestamp (e.g., at the time throughout the trajectory) can be used to determine which mode is to be labeled for a particular predicted trajectory.

In this example of FIG. 2, a predicted trajectory can be assigned to one of five different modes (e.g., modes 210, 212, 214, 216, 218). For example, if object 204 stays within a predetermined radius d (e.g., 1 meter, 2 meters, 10 meters, etc.) throughout the trajectory, the trajectory can be labeled mode 210, which indicates that object 204 is predicted to stay stationary. In another example, if a heading angle of object 204 is between −α degrees and +α degrees within a particular trajectory, the trajectory can be labeled mode 212, which indicates that object 204 is predicted to travel straight or in a forward direction. In some examples, a, can be a predetermined angle (e.g., 20 degrees). In another example, if a heading angle of object 204 is between α degrees and 90 degrees within a particular trajectory, the trajectory can be labeled mode 214, which indicates that object 204 is predicted to perform a left turn. In another example, if a heading angle of object 204 is between—α degrees and −90 degrees within a particular trajectory, the trajectory can be labeled mode 216, which indicates that object 204 is predicted to perform a right turn. In some examples, mode 218 can be assigned to a predicted trajectory that is not labeled with modes 210, 212, 214, 216. Mode 218 can include performing a U-turn, traveling in a reverse direction, or any other movements or maneuvers that are not part of modes 210, 212, 214, 216.

While five types of modes are described in example quadrant 200 in FIG. 2, those skilled in the art will recognize that the systems and techniques described herein may be implemented using a different number of modes that are defined based on the geometry of a predicted trajectory of an object.

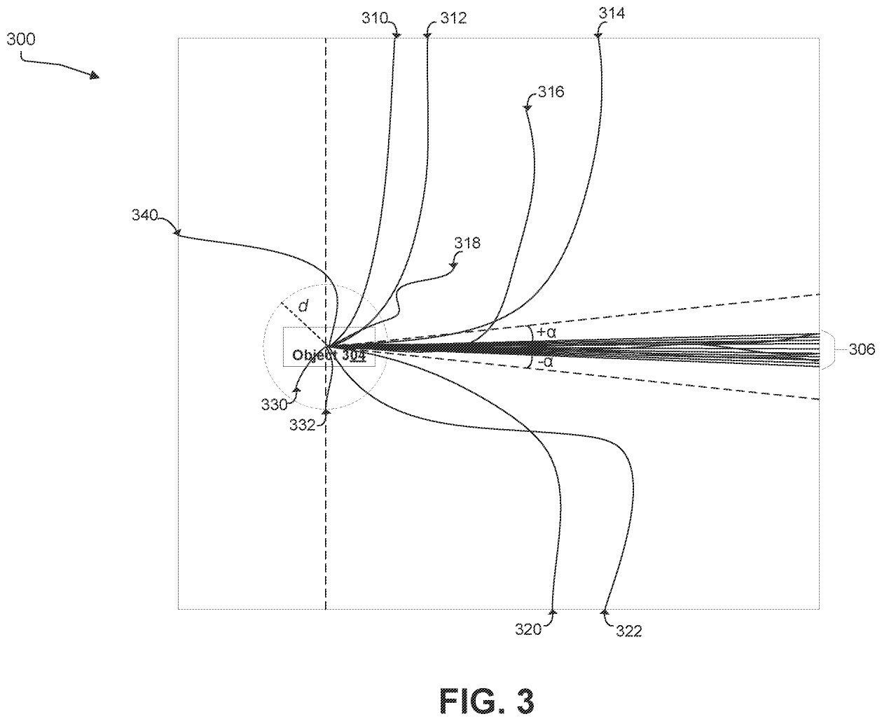

FIG. 3 a diagram 300 illustrating example predicted trajectories of an object. In some examples, a prediction stack (e.g., prediction stack 116 of AV 102 as illustrated in FIG. 1) can output multiple predicted trajectories/future paths (e.g., trajectories 306-340 in FIG. 3) that object 304 is predicted to take along with a probability (not shown in FIG. 3) associated with each path. In some cases, object 304 can be a vehicle, a bike, a pedestrian, or any applicable object that is around/near AV 102 (not shown). More specifically, object 304 is located within proximity of AV 102 that the current and future position of object 304 would affect the localization, planning, and/or control of AV 102, for example, whether AV 102 should yield to object 304 or assert. As follows, it is critical to accurately predict trajectories/future paths of object 304 so that AV 102 can safely and efficiently maneuver or operate.

In some examples, a mode can be labeled for each of trajectories 306-340 based on the geometry of each of trajectories 306-340 of object 304 (e.g., according to example quadrant 200 for labeling modes as illustrated in FIG. 2). For example, a heading angle of object 304 in the plurality of trajectories 306 is between −α degrees (e.g., −20 degrees) and +α degrees (e.g., +20 degrees). As follows, the plurality of trajectories 306 can be assigned to a mode for traveling straight (e.g., mode 212 as illustrated in FIG. 2). In another example, a heading angle of object 304 in trajectories 310, 312, 314, 316, 318 is between α degrees and 90 degrees. As follows, trajectories 310-318 can be assigned to a mode for performing a left turn (e.g., mode 214 as illustrated in FIG. 2). In another example, a heading angle of object 304 in trajectories 320, 322 is between −α degrees and −90 degrees. As follows, trajectories 320, 322 can be assigned to a mode for performing a right turn (e.g., mode 216 as illustrated in FIG. 2). In another example, object 304 in trajectories 330, 332 stays within a predetermined radius d (e.g., 1 meter or 2 meters). As follows, trajectories 330, 332 can be assigned to a mode for staying stationary (e.g., mode 210 as illustrated in FIG. 2). In another example, trajectory 340 can be assigned to a mode for performing a U-turn (e.g., mode 218 as illustrated in FIG. 2).

In some aspects, a probability can be assigned to modes based on one or more parameters associated with object 304, environmental elements, relevant predicted trajectories of object 304, or any applicable factors that may affect the future path/trajectory of object 304. More specifically, a probability for each mode can be determined based on characteristics of object 304 such as a type/classification (e.g., whether the object is a vehicle, pedestrian, bike, etc.), location, position, orientation, speed/velocity, acceleration, deceleration, configuration (e.g., size, dimension, model, made, year, etc.), and so on. In some examples, a probability for each mode can be determined based on environmental elements such as scene features or road elements. Non-limiting examples of environmental elements can include a location, region, lane geometries, road types, an azimuth and/or elevation angle of a road, traffic signs, existence of shoulder and/or bicycle lanes, existence of crossing lanes, scene visibility, illumination, types of other objects near object 304, distance between object 304 and other object(s), weather conditions, and so on. In some aspects, a probability for each mode can be determined based on one or more trajectories labeled with a respective mode and probabilities of respective trajectories. For example, probabilities associated with trajectories 310-318 can be used in determining a probability associated with a mode for performing a left turn (e.g., mode 214 as illustrated in FIG. 2). In another example, probabilities associated with trajectories 320, 322 can be taken into account for determining a probability associated with a mode for performing a right turn (e.g., mode 216 as illustrated in FIG. 2).

In some cases, the systems and techniques described herein can utilize mode classifications and associated probabilities (e.g., modes and associated probabilities determined as described above) for operations of AV 102. More specifically, a combination of one or more modes can be used for operations of AV 102 such as localization, planning, and control of AV 102 instead of relying on a trajectory that has the highest probability. For example, when one of the plurality of trajectories 306 has the highest probability among trajectories 306-340 (or even when all of the plurality of trajectories 306 has a higher probability than trajectories 310-340) and indicates that object 304 is most likely predicted to travel in a forward direction, the systems and techniques described herein may look at modes for performing a right turn, performing a left turn, staying stationary, or performing a U-turn and associated probabilities in localizing, planning, and/or controlling of AV 102.

In some examples, the systems and techniques described herein may exclude a particular mode in determining operations of AV 102 (e.g., localizing, planning, and/or controlling AV 102) if a probability associated with the particular mode is below a probability threshold (e.g., 0.1 or 10% or any other threshold). For example, if the probability associated with a mode for performing a U-turn is 0.01, the systems and techniques of the present disclosure can assume that object 304 is unlikely to perform a U-turn and determine/plan a behavior or maneuver of AV 102 that does not prepare for a U-turn of object 304.

Furthermore, the systems and techniques described herein can use positional uncertainties (e.g., probabilities) for each timestamp and each mode to determine the probability of a safety critical event (e.g., a collision/crash or a near miss between AV 102 and object 304) instead of looking at the mean prediction of the mode that has the highest probability.

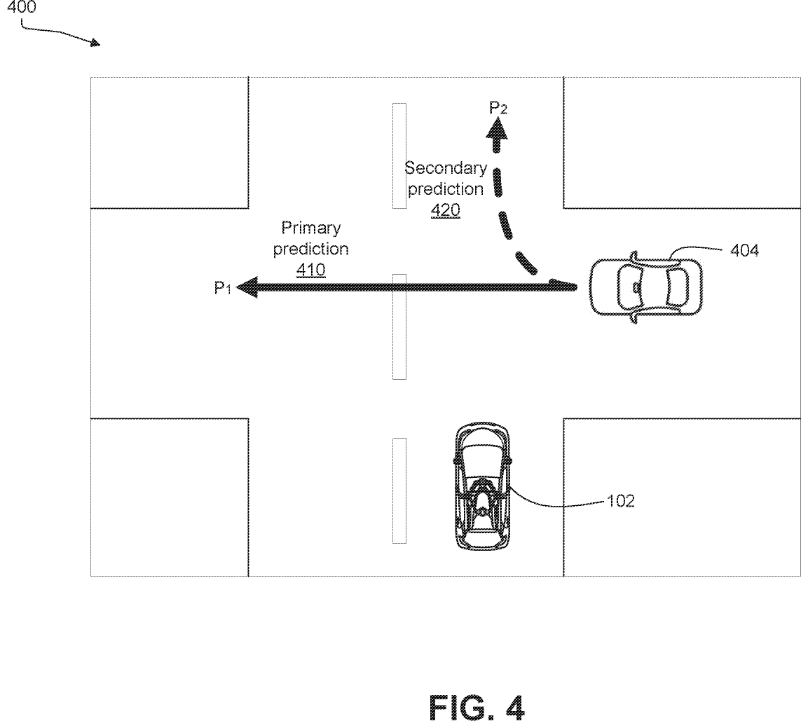

FIG. 4 illustrates an example road environment 400 for trajectory predictions of a vehicle 404 based on geometric anchoring. More specifically, road environment 400 comprises AV 102 and vehicle 404 at an intersection. As shown, primary prediction 410 of a mode of vehicle 404 predicts that vehicle 404 is most likely to travel in a forward direction from a frame of reference of AV 102 at a time between a first timestamp (e.g., time t) and a second timestamp (e.g., time t+k second(s)). Also, secondary prediction 420 of a mode of vehicle 404 predicts that vehicle 404 is likely to perform a right turn and assert at the time between the first timestamp (e.g., time t) and the second timestamp (e.g., time t+k second(s)). In some examples, primary prediction 410 is associated with a probability P₁ and secondary prediction 420 is associated with a probability P₂ that is lower than P₁ but higher than a probability threshold (e.g., 0.1 or 10% or any other threshold).

Based on both primary prediction 410 and secondary prediction 420, AV 102 (e.g., localization stack 114, control stack 122, planning stack 118, etc.) can plan or adjust the behavior of AV 102 to slow down and yield to vehicle 404 in case vehicle 404 does perform a right turn. As follows, a right turn of vehicle 404 can be captured earlier so that AV 102 can plan earlier (e.g., a few ticks or seconds earlier) to drive at a lower speed, slowly brake to yield to vehicle 404 or to keep a safe distance from vehicle 404. If AV 102 were to plan based solely on a few trajectories that may have higher probabilities but exclusively belong to a mode for driving in a forward direction, AV 102 would have missed secondary prediction 420 and had to hard brake (thus less comfort) or collided with vehicle 404 (thus lower safety). Based on multi-modal predictions that cover different semantic behaviors of vehicle 404, a safety critical event (e.g., a collision between AV 102 and vehicle 404) or a hard brake could be avoided, thereby improving both safety and comfort of operations of AV 102. In other words, multi-modal predictions to cover different behaviors of vehicle 404 (e.g., traveling in a forward direction or performing a right turn) would result in improved safety and comfort of operations of AV 102 as planning stack 118 of AV 102 can respond to a lower probability event earlier.

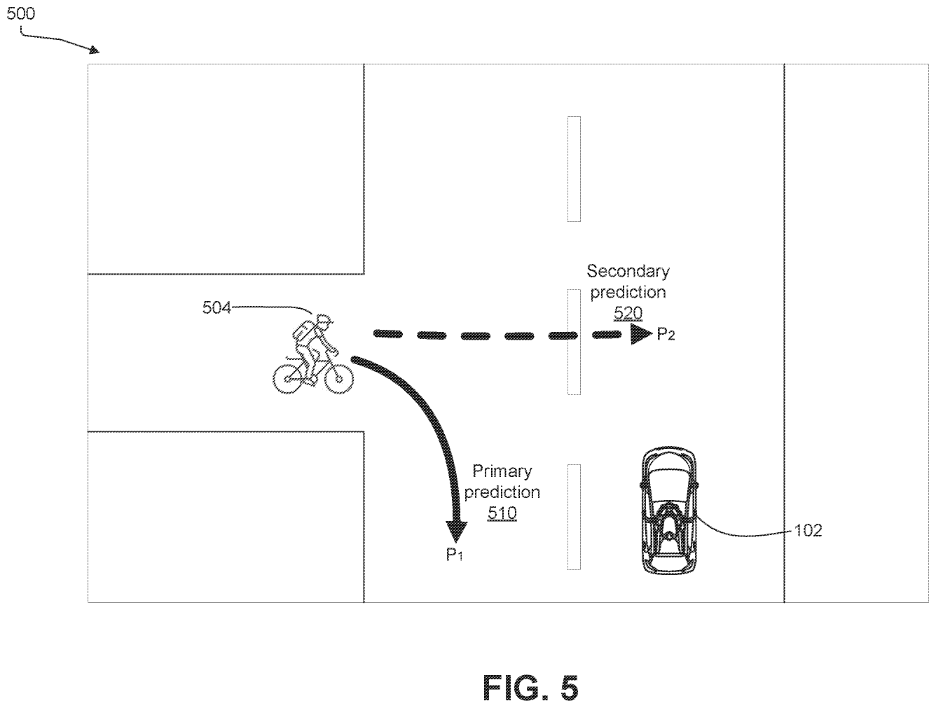

FIG. 5 illustrates an example road environment 500 for trajectory predictions of a bike 504 based on geometric anchoring. More specifically, road environment 400 comprises AV 102 and object bike 504 at a 3-way intersection (e.g., T-intersection). As shown, primary prediction 410 of a mode of bike 504 predicts that bike 504 is most likely to perform a right turn at a time between a first timestamp (e.g., time t) and a second timestamp (e.g., time t+k second(s)). Also, secondary prediction 420 of a mode of bike 504 predicts that bike 504 is likely to travel in a forward direction from a frame of reference of AV 102 at the time between the first timestamp (e.g., time t) and the second timestamp (e.g., time t+k second(s)). In some examples, primary prediction 410 is associated with a probability P₁ and secondary prediction 420 is associated with a probability P₂ that is lower than P₁ but higher than a probability threshold (e.g., 0.1 or 10%).

Based on primary prediction 510 and secondary prediction 520, AV 102 (e.g., localization stack 114, control stack 122, planning stack 118, etc.) can plan or adjust the behavior of AV 102 to avoid any safety critical event (e.g., a collision with bike 504 or a near miss) in case bike 504 does travel straight. More specifically, AV 102 may plan earlier (e.g., a few ticks or seconds earlier than what would have occurred if AV 102 were to plan solely based on primary prediction 510) to drive at a little higher speed to pass through before bike 504 enters the land where AV 102 is driving. Alternatively, based on the current location, position, and speed of bike 504, AV 102 may plan to drive at a lower speed to yield to bike 504. Based on the multi-modal formulation that produces a wider mode coverage, AV 102 can prepare for a mode that could have been missed and respond to a lower probability event earlier, thereby improving the safety and comfort of operations of AV 102.

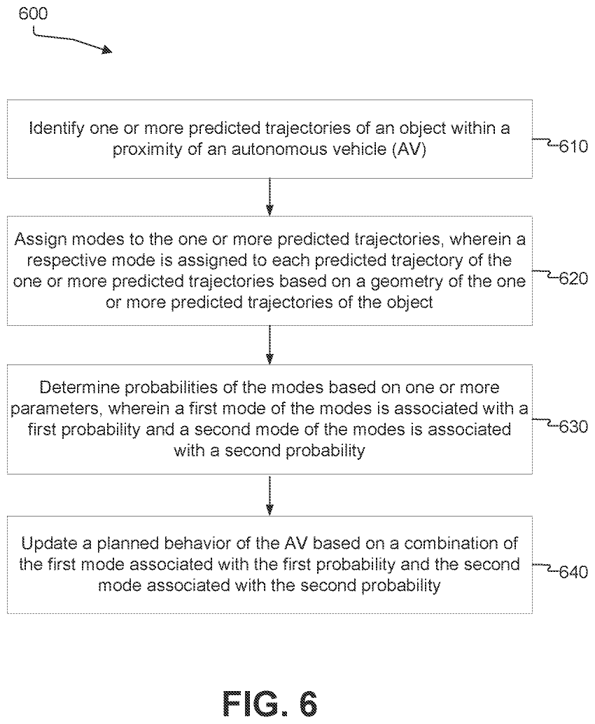

FIG. 6 illustrates a flowchart illustrating an example process 600 for routing an AV in a flood condition. Although the example process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At block 610, process 600 includes identifying one or more predicted trajectories of an object within a proximity of an autonomous vehicle (AV). In some examples, the one or more predicted trajectories correspond to a time between a first timestamp (e.g., time t) and a second timestamp (e.g., time t+k second(s) or future endpoint). For example, local computing device 110 (e.g., via prediction stack 116) can identify one or more predicted trajectories of an object (e.g., a vehicle, pedestrian, or bike such as object 204, object 304, vehicle 404, bike 504, etc.), which is located within the proximity of AV 102 (e.g., a proximity that would influence the localization, planning, and/or control of AV 102). In some examples, the object is located within a proximity of AV 102 that has a chance of resulting in a safety critical event (e.g., a collision or a near miss). In some aspects, the predicted trajectories (e.g., trajectories 306-340) can be associated with probabilities of occurrence over the time between the first timestamp and the second timestamp.

At block 620, process 600 includes assigning modes to the one or more predicted trajectories. In some examples, the process 600 can assign a respective mode to each predicted trajectory of the one or more predicted trajectories based on a geometry of the predicted trajectory of the object. For example, local computing device 110 (e.g., via prediction stack 116) can assign modes (e.g., modes 210, 212, 214, 216, 218 as shown on example quadrant 200 for labeling modes) to the predicted trajectories based on the geometry of predicted trajectories of object 204. In some examples, modes can comprise any number of semantic behaviors such as performing a turn, performing a U-turn, traveling in a forward direction from a frame of reference of the AV, traveling in a reverse direction from a frame of reference of the AV, and/or staying stationary.

In some examples, the geometry can include an angle and vector of the object at the time between the first timestamp (e.g., time t) and the second timestamp (e.g., time t+k seconds or future endpoint). For example, a heading angle of object 204 can determine which mode needs to be assigned to a particular trajectory at the time between time t and time t+k seconds. As follows, one or more predicted trajectories can be grouped and/or assigned to a mode based on the geometry of the predicted trajectories of the object (e.g., mode 210 indicating that object 204 is predicted to stay stationary, mode 212 indicating that object 204 is predicted to drive in a forward direction, mode 214 indicating that object 204 is predicted to perform a left turn, mode 216 indicating that object 204 is predicted to perform a left turn, or mode 218 indicating that object 204 is predicted to perform a U-turn or drive in a reverse direction), thereby providing multi-modal trajectory predictions to cover various semantic behaviors of the object.

At block 630, process 600 includes determining probabilities of the modes based on one or more parameters. In some examples, a first mode of the modes can be associated with a first probability and a second mode of the modes can be associated with a second probability. For example, local computing device 110 (e.g., prediction stack 116) can determine probabilities of the modes based on one or more parameters relating to characteristics of object 304 (e.g., a type, size, position, speed of the object), environmental elements including scene features and/or road elements where the object or AV 102 is located (e.g., location, region, road geometries such as a shape of a road, land geometries such as a number of lanes, a width of lanes, etc., surrounding scene features such as buildings, crossing lanes, traffic signs, etc.), relevant predicted trajectories of the object that are labeled with a respective mode, or any other applicable factors that may affect the trajectory of the object at the time between the first timestamp and the second timestamp.

At block 640, process 600 includes updating a planned behavior of the AV based on the second mode associated with the second probability. In some examples, the second probability can be lower than the first probability. For example, local computing device 110 (e.g., planning stack 118) can adjust or update a planned behavior of AV 102 based on a combination of the first mode associated with the first probability and the second mode associated with the second probability. In some aspects, a planned behavior of the AV can be adjusted or updated based on the first mode associated with the first possibility, a second mode associated with the second possibility, or a combination thereof.

In some examples, the second probability can be lower than the first probability. As illustrated with respect to FIG. 4, planning stack of AV 102 can prepare AV 102 to drive at a lower speed to yield to vehicle 404 based on secondary prediction 420 (e.g., a mode for performing a right turn) that has a low probability than primary prediction 410. In another example with respect to FIG. 5, based on secondary prediction 520 that has a lower probability than primary prediction 510, planning stack of AV 102 can prepare AV 102 to drive at a higher speed than it would have if bike 504 were not to travel in a forward direction to enter the lane where AV 102 is driving so that AV 102 can avoid a collision with bike 504.

In some cases, adjusting or updating the planned behavior of the AV can include determining a counterfactual scenario if the object had not taken the one or more predicted trajectories. For example, local computing device 110 (e.g., via planning stack 118) can determine a counterfactual scenario if object 304 had not taken any of trajectories 306-340 to ensure that there is any missing trajectory that local computing device 110 should prepare for the worst-case scenario and adjust the behavior of AV 102 accordingly.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some aspects, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communication interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some examples, a hardware service that performs a particular function can include the software component stored in a computer-readable medium in connection with the necessary hardware components, such as processor 710, connection 705, output device 735, etc., to carry out the function.

Examples and aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples and/or aspects of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples and aspects described above are provided by way of illustration only and should not be construed to limit the scope of the disclosure. For example, the principles herein apply equally to optimization as well as general improvements. Various modifications and changes may be made to the principles described herein without following the examples, aspects, and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: identify one or more predicted trajectories of an object within a proximity of an autonomous vehicle (AV), the one or more predicted trajectories corresponding to a time between a first timestamp and a second timestamp; assign modes to the one or more predicted trajectories, wherein a respective mode is assigned to each predicted trajectory of the one or more predicted trajectories based on a geometry of the one or more predicted trajectories of the object; determine probabilities of the modes based on one or more parameters, wherein a first mode of the modes is associated with a first probability and a second mode of the modes is associated with a second probability; and update a planned behavior of the AV based on a combination of the first mode associated with first possibility and the second mode associated with the second probability.

Aspect 2. The system of Aspect 1, wherein the second probability is lower than the first probability.

Aspect 3. The system of any of Aspects 1 or 2, wherein the geometry includes at least one of an angle of the object at the time between the first timestamp and the second timestamp and a vector of the object at the time between the first timestamp and the second timestamp.

Aspect 4. The system of any of Aspects 1 to 3, wherein the modes include at least one of performing a turn, performing a U-turn, traveling in a forward direction from a frame of reference of the AV, traveling in a reverse direction from a frame of reference of the AV, and staying stationary.

Aspect 5. The system of any of Aspects 1 to 4, wherein the one or more parameters are associated with object characteristics including at least one of a type of the object, a size of the object, a position of the object, and a speed of the object.

Aspect 6. The system of any of Aspects 1 to 5, wherein the one or more parameters are associated with environmental parameters including at least one of a location of the object, a region in which the object is located, a shape of a road in a scene associated with the AV, a number of lanes on the road, and one or more surrounding scene features.

Aspect 7. The system of any of Aspects 1 to 6, wherein the second probability is higher than a probability threshold.

Aspect 8. The system of any of Aspects 1 to 7, wherein updating the planned behavior of the AV includes: determining a counterfactual scenario if the object had not taken the one or more predicted trajectories.

Aspect 9. The system of any of Aspects 1 to 8, wherein the object is a pedestrian, a vehicle, or a bicycle.

Aspect 10. A method comprising: identifying one or more predicted trajectories of an object within a proximity of an autonomous vehicle (AV), the one or more predicted trajectories corresponding to a time between a first timestamp and a second timestamp; assigning modes to the one or more predicted trajectories, wherein a respective mode is assigned to each predicted trajectory of the one or more predicted trajectories based on a geometry of the one or more predicted trajectories of the object; determining probabilities of the modes based on one or more parameters, wherein a first mode of the modes is associated with a first probability and a second mode of the modes is associated with a second probability; and updating a planned behavior of the AV based on a combination of the first mode associated with the first probability and the second mode associated with the second probability.

Aspect 11. The method of Aspect 10, wherein the second probability is lower than the first probability.

Aspect 12. The method of any of Aspects 10 or 11, wherein the geometry includes at least one of an angle of the object at the time between the first timestamp and the second timestamp and a vector of the object at the time between the first timestamp and the second timestamp.

Aspect 13. The method of any of Aspects 10 to 12, wherein the modes include at least one of performing a turn, performing a U-turn, traveling in a forward direction from a frame of reference of the AV, traveling in a reverse direction from a frame of reference of the AV, and staying stationary.

Aspect 14. The method of any of Aspects 10 to 13, wherein the one or more parameters are associated with object characteristics including at least one of a type of the object, a size of the object, a position of the object, and a speed of the object.

Aspect 15. The method of any of Aspects 10 to 14, wherein the one or more parameters are associated with environmental parameters including at least one of a location of the object, a region in which the object is located, a shape of a road in a scene associated with the AV, a number of lanes on the road, and one or more surrounding scene features.

Aspect 16. The method of any of Aspects 10 to 15, wherein the second probability is higher than a probability threshold.

Aspect 17. The method of any of Aspects 10 to 16, wherein updating the planned behavior of the AV includes: determining a counterfactual scenario if the object had not taken the one or more predicted trajectories.

Aspect 18. A non-transitory computer-readable medium having stored thereon instructions which, when executed by one or more processors, cause the one or more processors to: perform a method according to any of Aspects 10 to 17.

Aspect 19. A system comprising means for performing a method according to any of Aspects 10 to 17.

Aspect 20. A computer-program product comprising instructions which, when executed by one or more processors, cause the one or more processors to perform a method according to any of Aspects 10 to 17.

Aspect 21. An autonomous vehicle comprising a computing device configured to perform a method according to any of Aspects 10 to 17.

What is claimed is:

1. A system comprising:
a memory; and
one or more processors coupled to the memory, the one or more processors being configured to:
identify one or more predicted trajectories of an object within a proximity of an autonomous vehicle (AV), the one or more predicted trajectories corresponding to a time between a first timestamp and a second timestamp;
assign modes to the one or more predicted trajectories, wherein a respective mode is assigned to each predicted trajectory of the one or more predicted trajectories based on a geometry of the one or more predicted trajectories of the object;
determine probabilities of the modes based on one or more parameters, wherein a first mode of the modes is associated with a first probability and a second mode of the modes is associated with a second probability; and
update a planned behavior of the AV based on a combination of the first mode associated with first possibility and the second mode associated with the second probability.

2. The system of claim 1, wherein the second probability is lower than the first probability.

3. The system of claim 1, wherein the geometry includes at least one of an angle of the object at the time between the first timestamp and the second timestamp and a vector of the object at the time between the first timestamp and the second timestamp.

4. The system of claim 1, wherein the modes include at least one of performing a turn, performing a U-turn, traveling in a forward direction from a frame of reference of the AV, traveling in a reverse direction from a frame of reference of the AV, and staying stationary.

5. The system of claim 1, wherein the one or more parameters are associated with object characteristics including at least one of a type of the object, a size of the object, a position of the object, and a speed of the object.

6. The system of claim 1, wherein the one or more parameters are associated with environmental parameters including at least one of a location of the object, a region in which the object is located, a shape of a road in a scene associated with the AV, a number of lanes on the road, and one or more surrounding scene features.

7. The system of claim 1, wherein the second probability is higher than a probability threshold.

8. The system of claim 1, wherein updating the planned behavior of the AV includes:
determining a counterfactual scenario if the object had not taken the one or more predicted trajectories.

9. The system of claim 1, wherein the object is a pedestrian, a vehicle, or a bicycle.

10. A method comprising:
identifying one or more predicted trajectories of an object within a proximity of an autonomous vehicle (AV), the one or more predicted trajectories corresponding to a time between a first timestamp and a second timestamp;
assigning modes to the one or more predicted trajectories, wherein a respective mode is assigned to each predicted trajectory of the one or more predicted trajectories based on a geometry of the one or more predicted trajectories of the object;
determining probabilities of the modes based on one or more parameters, wherein a first mode of the modes is associated with a first probability and a second mode of the modes is associated with a second probability; and
updating a planned behavior of the AV based on a combination of the first mode associated with the first probability and the second mode associated with the second probability.

11. The method of claim 10, wherein the second probability is lower than the first probability.

12. The method of claim 10, wherein the geometry includes at least one of an angle of the object at the time between the first timestamp and the second timestamp and a vector of the object at the time between the first timestamp and the second timestamp.

13. The method of claim 10, wherein the modes include at least one of performing a turn, performing a U-turn, traveling in a forward direction from a frame of reference of the AV, traveling in a reverse direction from a frame of reference of the AV, and staying stationary.

14. The method of claim 10, wherein the one or more parameters are associated with object characteristics including at least one of a type of the object, a size of the object, a position of the object, and a speed of the object.

15. The method of claim 10, wherein the one or more parameters are associated with environmental parameters including at least one of a location of the object, a region in which the object is located, a shape of a road in a scene associated with the AV, a number of lanes on the road, and one or more surrounding scene features.

16. The method of claim 10, wherein the second probability is higher than a probability threshold.

17. The method of claim 10, wherein updating the planned behavior of the AV includes:
determining a counterfactual scenario if the object had not taken the one or more predicted trajectories.

18. A non-transitory computer-readable medium having stored thereon instructions which, when executed by one or more processors, cause the one or more processors to:
identify one or more predicted trajectories of an object within a proximity of an autonomous vehicle (AV), the one or more predicted trajectories corresponding to a time between a first timestamp and a second timestamp;
assign modes to the one or more predicted trajectories, wherein a respective mode is assigned to each predicted trajectory of the one or more predicted trajectories based on a geometry of the one or more predicted trajectories of the object;
determine probabilities of the modes based on one or more parameters, wherein a first mode of the modes is associated with a first probability and a second mode of the modes is associated with a second probability; and
update a planned behavior of the AV based on a combination of the first mode associated with the first possibility and the second mode associated with the second probability.

19. The non-transitory computer-readable medium of claim 18, wherein the geometry includes at least one of an angle of the object at the time between the first timestamp and the second timestamp and a vector of the object at the time between the first timestamp and the second timestamp.

20. The non-transitory computer-readable medium of claim 18, wherein the modes include at least one of performing a turn, performing a U-turn, traveling in a forward direction from a frame of reference of the AV, traveling in a reverse direction from a frame of reference of the AV, and staying stationary.
